(19) United States
(12) Patent Application Publication
(10) Pub. No.: US 2019/0025975 A1
(43) Pub. Date: Jan. 24, 2019

(54) Controlling System and Method Provided for Electronic Device Equipped in Vehicle

(71) Applicants: Shanghai XPT Technology Limited, Shanghai City (CN); INTELLIGENCE & PARTNER LIMITED, HONG KONG (HK)

(72) Inventors: Mu-Jen Huang, Taipei City (TW); Ya-Li Tai, Taoyuan City (TW); Hsien-Chen Chen, Taipei City (TW)

(21) Appl. No.: 15/968,711

(22) Filed: May 1, 2018

(30) Foreign Application Priority Data
Jul. 19, 2017 (CN) 201710590920.7
Jul. 19, 2017 (CN) 201720878095.6

(51) Int. Cl. G06F 3/041; B60R 16/023; G01C 21/36

(52) U.S. Cl. CPC G06F 3/0416; G02B 27/01; G01C 21/3664; B60R 16/0231

(57) ABSTRACT

A controlling system for controlling an electronic device equipped in a vehicle. The controlling system includes a touch input device, a control unit and a display device. The touch input device is arranged on a roof of the vehicle and configured to receive inputs. The control unit is electrically connected to the touch input device and configured to control the operations of the electronic device based on the inputs. The electronic device is arranged elsewhere other than the roof of the vehicle. The display device arranged in front of a driver and configured to display at least one control option for the operations of the control unit.

### BACKGROUND OF THE INVENTION

### 1. Field of the Invention

The present invention relates to a controlling system and a controlling method provided for an electronic device equipped in a vehicle, and particularly to a controlling system and a controlling method facilitating input commands.

### 2. Description of the Prior Art

A modern vehicle equipped with at least one electronic device (e.g. a vehicle entertainment system, navigator, etc.) to help with the driver. The input interfaces(e.g. touch panel or button) of those electronic devices are generally arranged at the front center of the vehicle, e.g. the central console. A driver or a passenger may have to lean to operate the electronic devices through the input interfaces. This could be dangerous especially when driving. Alternatively, a vehicle may furnish auxiliary inputs on the steering wheel or on the center armrest for the driver to use. However, any input could interfere the operation of the steering wheel. Moreover, auxiliary inputs arranged on the center armrest could be accidentally touched and sometimes drinks may spill on them causing malfunction. Given the above, there exists no satisfactory input arrangement on vehicles in nowadays.

### SUMMARY OF THE INVENTION

Accordingly, the present invention provides a controlling system and a method for controlling an electronic device equipped in a vehicle.

The controlling system of the present invention includes: a touch input device, a control unit and a display device. The touch input device is arranged on a roof of the vehicle and configured to receive an inputs. The control unit is electrically connected to the touch input device and configured to control operations of the electronic device based on the inputs. The electronic device is arranged elsewhere other than the roof of the vehicle. The display device is arranged in front of a driver and configured to display at least one control option for the operations of the control unit.

The controlling method of the present invention includes: providing a touch input device on a roof of the vehicle; receiving, through the touch input device, an inputs; controlling, through a control unit, operations of the electronic device based on the inputs; and displaying at least one control option for the operations of the control unit in front of a driver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a vehicle electronic device controlling system according to an embodiment of the present invention.

FIG. 2 is a schematic diagram of the vehicle electronic device controlling system shown in FIG. 1 from a side view.

FIG. 3 is a schematic diagram of a vehicle electronic device controlling system according to another embodiment of the present invention.

FIG. 4 is a schematic diagram of the vehicle electronic device controlling system shown in FIG. 3 from a side view.

FIG. 5 is a flowchart of a driver instruction method according to an embodiment of the present invention.

### DETAILED DESCRIPTION

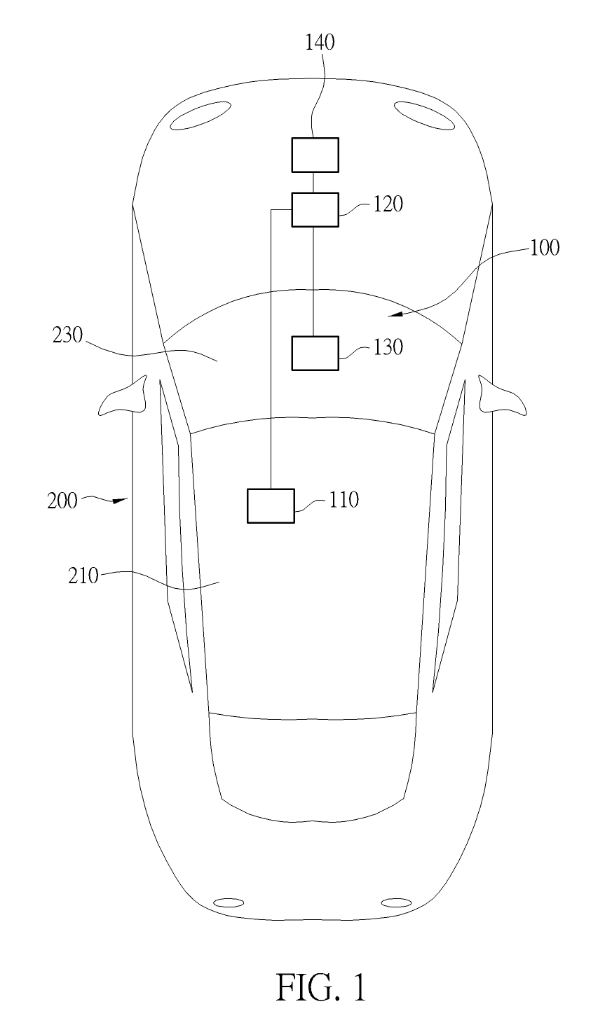

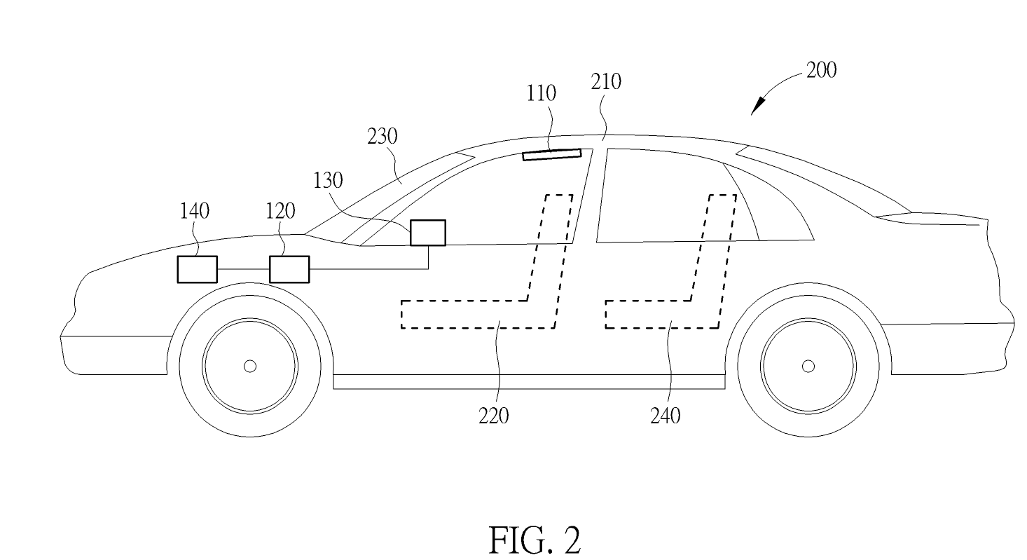

FIG. 1 and FIG. 2 illustrate the controlling system 100 for controlling an electronic device equipped in a vehicle in accordance with the present invention. As both shown, the controlling system 100 of the present invention includes a touch input device 110 and a control unit 120. The touch input device 110 is arranged on a roof 210 of a vehicle 200 and configured to receive a touch input. The touch input device 110 may be a resistive or capacitive touch panel including transparent conducting structure (e.g. the transparent conducting structure formed by Indium Tin Oxide (ITO)). The present invention is not limited herein. The touch input device 110 may be an acoustic, an electro-magnetic, an infrared or an optics touch panel. The touch input device 110 is arranged above a driver seat 220 of the vehicle 200 (e.g. right on the top of the driver seat 220) such that the driver may conveniently input commands. On the other hand, if there is a sunroof arranged on the vehicle 200, the touch input device 110 may be arranged on the sunroof, and the size of the touch input device 110 is smaller than that of the sunroof. The touch input device 110 is configured to receive the touch input from the driver, such as single-touch/multi-touch inputs.

In the embodiment of the present invention, to prevent distraction, the touch input device 110 is without a display function. In other embodiments of the present invention, the touch input device 110 may perform the image display function according to different design needs.

The control unit 120 is electrically connected to touch input device 110, and configured to control operations of an electronic device based on the way the touch input is formed. For instance, the system may be preprogramed to recognize a click, a drag, and a long-time press on; each of them represents an operation of the electronic device.

It should be noted that in the present invention the electronic device is arranged elsewhere other than the roof 210 of the vehicle 200. For example, the control unit 120 may control the operations of an audio device equipped in the vehicle 200 for volume adjustment, track selection or radio station switching according to the touch input. The control unit 120 may also control the operations of an image display device equipped in the vehicle 200 for playing, pausing or stopping based on the touch input. The control unit 120 may further control the operations of a navigation device equipped in the vehicle 200 for planning a route or searching locations based on the touch input. The control unit 120 may yet also control the operations of a hands-free communicating device for answering or hanging up a call or searching a contact list according to the touch input. The operations of an electronic device stated above are not exhausted and for exemplary purposes only.

According to the arrangements above, the driver may simply use his/her hand to issue operating commands through the touch input device 110 arranged on the roof 210 to control the operations of electronic devices equipped in the vehicle 200. That is, the driver, while driving, can easily control the electronic devices without leaning or interfering the operation of the steering wheel. Therefore, the present invention provides a more convenient and safer means for drivers to control electronic devices equipped in vehicles.

Besides, the controlling system 100 of the present invention may include a display device 130 for displaying at least one control option in front of the driver for the operations of the control unit 120. For example, the display device 130 may be a head-up display for projecting the control options on the windshield 230 (or on the combiner unit). The images therefore displayed on the windshields 230 may be fused with the scene ahead without affecting the driver's view. In this way, the driver may conveniently choose and control operations of different electronic devices without removing his/her sight. Additionally, the display device 130 may be a liquid crystal display (LCD) device or any display device of other types.

Moreover, the controlling system 100 of the present invention may further include a storage unit 140. The storage unit 140 stores the trace coordinates of the touch input and/or the characters or numbers corresponding to the touch input. For example, the driver may perform a handwriting via the touch input device 11; the storage unit 140 then stores the trace coordinates of the handwriting and received by the touch input device 110. Alternatively, the trace coordinates of the handwriting may be transforms into the corresponding characters or numbers and stored in the storage unit 140. Later when the driver handwrites via the touch input device 110, the display device 130 may correspondingly display the traces or display the corresponding characters or numbers for the driver's confirmation.

According to the arrangements above, the driver may simply raise his/her hand to hand write via the touch input device 110 on the roof 210 to record the handwriting content without being distracted to look for a pen or a smart phone. Therefore, the safety can be further improved.

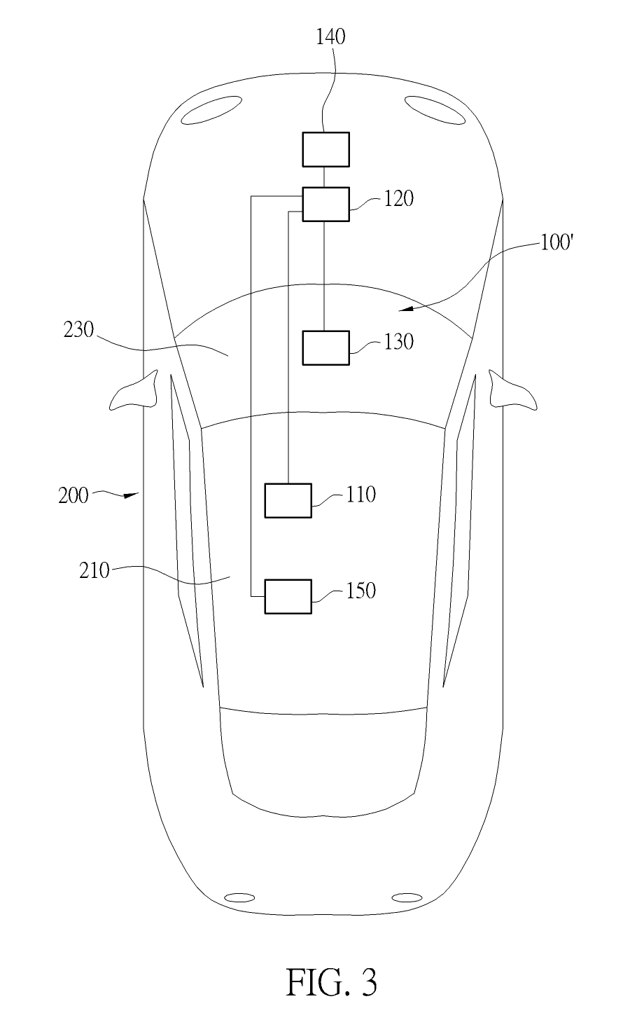

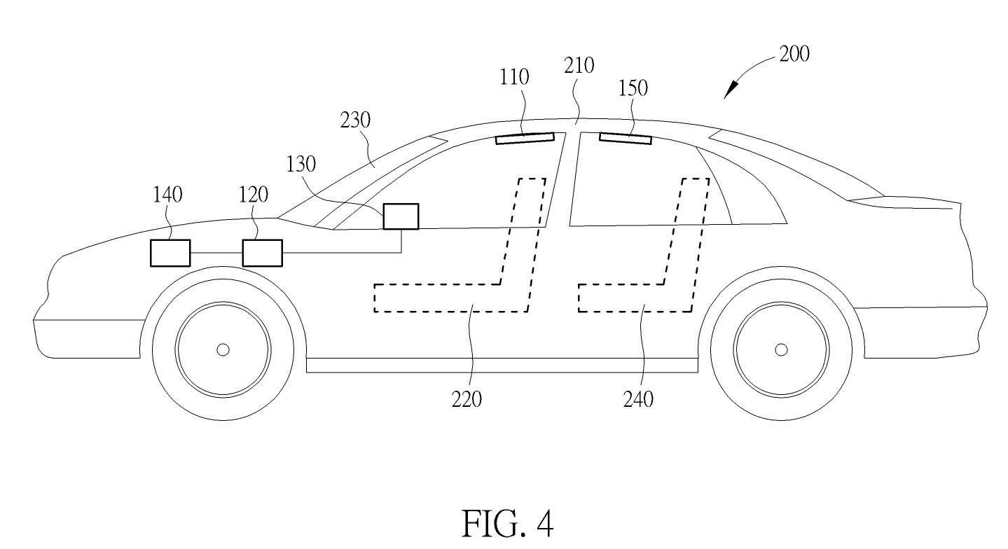

FIG. 3 and FIG. 4 illustrate another embodiment of the controlling system 100′ in accordance with the present invention. As shown, aside from the touch input device 110, the control unit 120, the display device 130 and the storage unit 140, the controlling system 100′ further includes an auxiliary touch input device 150 arranged on the roof 210 of the vehicle 200. The auxiliary touch input device 150 is arranged above a back seat 240 of the vehicle 200, and configured to receive a touch input (e.g. a single-touch/multi-touch input) from the passenger sitting in the back. Similarly, the auxiliary touch input device 150 may be a resistive or a capacitive touch panel including transparent conducting structure (e.g. the transparent conducting structure formed by Indium Tin Oxide (ITO)). The present invention is not limited herein. The auxiliary touch input device 150 may be an acoustic, an electro-magnetic, an infrared or an optics touch panel. The control unit 120 is electrically connected to the auxiliary touch input device 150, and the control unit 120 may also control operations of an electronic device equipped in the vehicle 200 according to how the touch input is issued and received by the auxiliary touch input device 150. For instance, the touch input can be a click, a drag, or a long-time press on. In this way, the passenger sitting in the back cam also conveniently and easily control operations of the electronic device equipped in the vehicle 200 through the auxiliary touch input device 150.

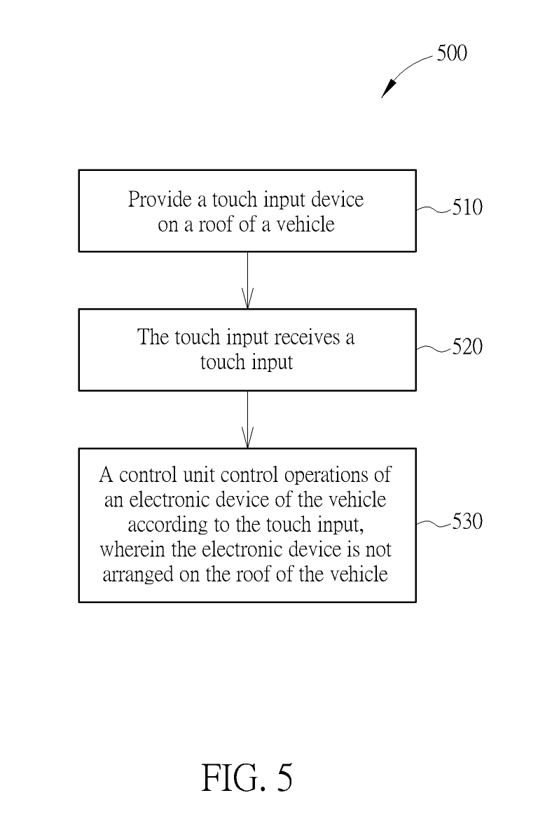

FIG. 5 is a flowchart showing the controlling method according to an embodiment of the present invention. The method includes the following steps:

Step 510: providing a touch input device on a roof of a vehicle;

Step 520: receiving a touch input through the touch input; and

Step 530: controlling operations of an electronic device equipped in the vehicle, through a control unit, based on the touch input. The electronic device is arranged elsewhere other than the roof of the vehicle.

Based on the foregoing, the controlling system of the present invention provides a more convenient and safer way to control the operations of electronic devices equipped in a vehicle. Additionally, since the placement of the controlling system is on the roof of the vehicle, the driver of the vehicle can easily reach it without moving body or removing eyesight. Such arrangement further prevents false touches and physical damages caused by liquid.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controlling system for controlling the operations of an electronic device in a vehicle comprising:
a touch input device arranged on a roof of the vehicle and configured to receive an inputs;
a control unit electrically connected to the touch input device and configured to control the operations of the electronic device based on the inputs, wherein the electronic device is arranged elsewhere other than the roof of the vehicle; and
a display device arranged in front of a driver and configured to display at least one control option for the operations of the control unit.

2. The vehicle electronic device controlling system of claim 1, further comprising a storage unit configured to store trace coordinates of the input and/or characters or numbers corresponding to the input.

3. The vehicle electronic device controlling system of claim 1, wherein the display device is a head-up display.

4. The vehicle electronic device controlling system of claim 1, wherein the touch input device is without a display function.

5. The vehicle electronic device controlling system of claim 1, wherein the touch input device is arranged on the sunroof of the vehicle, and a size of the touch input device is smaller than that of the sunroof.

6. The vehicle electronic device controlling system of claim 1, wherein the touch input device is arranged above the driver's seat of the vehicle.

7. The vehicle electronic device controlling system of claim 1, wherein the touch input is a multi-touch input.

8. The vehicle electronic device controlling system of claim 1, wherein the electronic device is an audio device.

9. The vehicle electronic device controlling system of claim 1, wherein the electronic device is an image display device.

10. The vehicle electronic device controlling system of claim 1, wherein the electronic device is a navigation device.

11. The vehicle electronic device controlling system of claim 1, wherein the electronic device is a hands-free communicating device.

12. A controlling method for controlling an electronic device in a vehicle comprising:
providing a touch input device on a roof of the vehicle;
receiving, through the touch input device, an inputs;
controlling, through a control unit, operations of the electronic device based on the inputs, wherein the electronic device is arranged elsewhere other than the roof of the vehicle; and
displaying at least one control option for the operations of the control unit in front of a driver.

13. The vehicle electronic device control method of claim 12, further comprising storing trace coordinates of the input and/or characters or numbers corresponding to the input.

14. The vehicle electronic device control method of claim 12, wherein the touch input is a multi-touch input.

15. The vehicle electronic device control method of claim 12, wherein the control unit controls the operation of an audio device equipped in the vehicle based on the input.

16. The vehicle electronic device control method of claim 12, wherein the control unit controls the operation of an image display device equipped in the vehicle based on the input.

17. The vehicle electronic device control method of claim 12, wherein the control unit controls the operation of a navigation device equipped in the vehicle based on the input.

18. The vehicle electronic device control method of claim 12, wherein the control unit controls the operation of a hands-free communicating device equipped in the vehicle based on the input.
